(19) United States
(12) Patent Application Publication
(10) Pub. No.: US 2012/0075169 A1
(43) Pub. Date: Mar. 29, 2012

(54) HEAD-MOUNTED DISPLAY

(75) Inventors: Yoichi IBA, Tokyo (JP); Seiji TATSUTA, Tokyo (JP); Ryohei SUGIHARA, Tokyo (JP); Teruo TOMITA, Kawasaki-shi (JP)

(73) Assignee: OLYMPUS CORPORATION, Tokyo (JP)

(21) Appl. No.: 13/248,409

(22) Filed: Sep. 29, 2011

(30) Foreign Application Priority Data
Sep. 29, 2010 (JP) 2010-218773
Sep. 29, 2010 (JP) 2010-218910

(51) Int. Cl. G09G 5/00

(52) U.S. Cl. 345/8

(57) ABSTRACT

A head-mounted display includes a mounting section that includes a first support target section, and is worn along the back of the head of the user, the first support target section being supported by a base of one of the right and left ears, and an arm section that is formed to extend forward from one end of the mounting section positioned on the side of the first support target section along one temporal region, and includes an eye piece that faces one of the right and left eyes, the eye piece being provided at a front-side end of the arm section. The position of the center of gravity of the head-mounted display in the horizontal direction is set to a position on the front side of the first support target section or a position around the first support target section.

Japanese Patent Application No. 2010-218773 filed on Sep. 29, 2010 and Japanese Patent Application No. 2010-218910 filed on Sep. 29, 2010, are hereby incorporated by reference in their entirety.

### BACKGROUND

The present invention relates to a head-mounted display and the like.

A head-mounted display (hereinafter appropriately abbreviated as “HMD”) has been known as a head-wearable display. Head-mounted displays (HMD) are classified into a non-see-through HMD (i.e., the eyes of the user are completely covered when the user wears the HMD, and the user cannot observe the external world) and a see-through HMD. The see-through HMD is classified as a video see-through HMD (i.e., an image of the external world captured by a video camera is displayed on a display section) or an optical see-through HMD. The optical see-through HMD is designed so that an image displayed on the display section and the external world are simultaneously brought into the field of view of the user using optical parts. For example, JP-A-2005-181440 and JP-A-2004-304296 disclose a related-art optical see-through HMD. JP-A-2005-195425 discloses a related-art head-mounted headphone apparatus, for example.

### SUMMARY

According to one aspect of the invention, there is provided a head-mounted display comprising:

a mounting section that includes a first support target section, and is worn along a back of a head of a user so that the mounting section holds each side of the head of the user, the first support target section being supported by a base of one of a right ear and a left ear of the user; and

an arm section that is formed to extend forward from one end of the mounting section positioned on a side of the first support target section along one temporal region of the user, and includes an eye piece that faces one of a right eye and a left eye of the user, the eye piece being provided at a front-side end of the arm section,

a position of a center of gravity of the head-mounted display in a horizontal direction being set to a position on a front side of the first support target section or a position around the first support target section when viewed from a side of the one temporal region.

According to another aspect of the invention, there is provided a head-mounted display comprising:

a mounting section that includes a first support target section, and is worn along a back of a head of a user so that the mounting section holds each side of the head of the user, the first support target section being supported by a base of one of a right ear and a left ear of the user; and

an arm section that is formed to extend forward from one end of the mounting section positioned on a side of the first support target section along one temporal region of the user, and includes an eye piece that faces one of a right eye and a left eye of the user, the eye piece being provided at a front-side end of the arm section,

an electronic part at least including a driver that drives a display section that generates a display image displayed on the eye piece being provided in a housing included in the arm section.

### BRIEF DESCRIPTION OF THE DRAWINGS

FIG. 1 is a perspective view showing a configuration example of a head-mounted display according to one embodiment of the invention.

FIG. 2 is a right side view showing a configuration example of a head-mounted display according to one embodiment of the invention.

FIG. 3 is a rear view showing a configuration example of a head-mounted display according to one embodiment of the invention.

FIG. 4 is a plan view showing a head-mounted display according to one embodiment of the invention in a folded state.

FIG. 5 is a view showing a head-mounted display according to one embodiment of the invention in a state in which the head-mounted display is worn around the neck.

FIG. 6 is a view illustrative of the center-of-gravity position setting and the angle setting of a head-mounted display.

FIGS. 7A and 7B are views illustrative of the angle setting of a head-mounted display.

FIGS. 8A and 8B are views illustrative of the angle setting of a head-mounted display.

FIGS. 9A and 9B are views illustrative of a mounting example in which a mounting section of a head-mounted display does not come in contact with the back of the head.

FIGS. 10A and 10B are views illustrative of an eye piece position adjustment and a mounting example of a head-mounted display in a state in which the user wears glasses.

FIGS. 11A and 11B are views illustrative of a method that provides a protrusion on the head-facing side surface of a head-mounted display.

FIGS. 12A and 12B are views illustrative of a method that provides first to third protrusions on the head-facing side surface of a head-mounted display.

FIG. 13 is a view illustrative of a method that provides first to third protrusions on the head-facing side surface of a head-mounted display.

FIGS. 14A and 14B are views illustrative of a method that provides electronic parts in a housing of an arm section of a head-mounted display.

FIG. 15 shows a connection configuration example of electronic parts provided in a head-mounted display.

FIGS. 16A and 16B are views illustrative of a modification of a head-mounted display according to one embodiment of the invention.

### DESCRIPTION OF EXEMPLARY EMBODIMENTS

Several aspects of the invention may provide a head-mounted display and the like that make it possible to stably hold an eye piece, and reduce the burden on the user when the user wears the head-mounted display, for example.

Several aspects of the invention may provide a head-mounted display and the like that make it possible to stably hold an eye piece while providing necessary electronic parts in the head-mounted display, for example.

According to one embodiment of the invention, there is provided a head-mounted display comprising:

a mounting section that includes a first support target section, and is worn along a back of a head of a user so that the mounting section holds each side of the head of the user, the first support target section being supported by a base of one of a right ear and a left ear of the user; and

an arm section that is formed to extend forward from one end of the mounting section positioned on a side of the first support target section along one temporal region of the user, and includes an eye piece that faces one of a right eye and a left eye of the user, the eye piece being provided at a front-side end of the arm section,

a position of a center of gravity of the head-mounted display in a horizontal direction being set to a position on a front side of the first support target section or a position around the first support target section when viewed from a side of the one temporal region.

According to the head-mounted display, the first support target section of the mounting section is supported by the base of one of the right ear and the left ear of the user, and the mounting section is worn along the back of the head of the user so that the mounting section holds each side of the head of the user. The eye piece that faces one of the right eye and the left eye of the user is provided at the front-side end of the arm section that is formed to extend forward from one end positioned on the side of the first support target section of the mounting section.

The position of the center of gravity of the head-mounted display in the horizontal direction is set to a position on the front side of the first support target section or the position of the first support target section. An upward force is applied to the rear end of the mounting section due to gravity when setting the position of the center of gravity as described above. However, since the rear end of the mounting section comes in contact with the back of the head, upward displacement of the rear end of the mounting section can be prevented. This makes it possible to stably hold the eye piece, for example.

In the head-mounted display,

an angle θ formed by a first direction and a second direction may be equal to or greater than 145°, the first direction being a direction from the first support target section to a rear end of the mounting section, and the second direction being a direction from the first support target section to the eye piece provided on the arm section when viewed from the side of the one temporal region.

According to the above feature, the mounting section does not interfere with the back of the neck even if the user moves his head around. This makes it possible to stably hold the eye piece in front of the visual axis of the user.

In the head-mounted display,

the angle θ may be equal to or greater than 145° and less than 220°.

According to the above feature, a situation in which the eye piece is displaced downward around the ear of the user even if the position of the center of gravity in the horizontal direction is set to a position on the front side of the first support target section, for example.

In the head-mounted display,

the angle θ may be equal to or greater than 145° and less than 180°.

According to the above feature, the position of the center of gravity of the head-mounted display in the vertical direction can be set to a position below the first support target section, so that the mounting (wearing) stability and the like can be improved.

In the head-mounted display,

a position of the center of gravity in a vertical direction may be set to a position below the first support target section or a position around the first support target section when viewed from the side of the one temporal region.

The mounting (wearing) stability of the head-mounted display can be further improved by setting the position of the center of gravity in the vertical direction being to a position below the first support target section or the position of the first support target section.

In the head-mounted display,

the mounting section may include a second support target section that is supported by the base of the other of the right ear and the left ear.

According to the above feature, the mounting section can be supported by the base of each ear, so that the mounting (wearing) stability can be improved.

The head-mounted display may further comprise:

a protrusion that is provided on at least one of a head-facing side surface of the second support target section of the mounting section, a head-facing side surface of the first support target section of the mounting section, and a head-facing side surface of the arm section on a side of the first support target section.

A situation in which the mounting section is slidingly displaced toward the back of the head can be prevented by providing the protrusion.

The head-mounted display may further comprise:

a first protrusion that is provided on a head-facing side surface of the second support target section of the mounting section;

a second protrusion that is provided on a head-facing side surface of the first support target section of the mounting section or a head-facing side surface of the arm section on a side of the first support target section; and

a third protrusion that is provided on a head-facing side surface of the mounting section on a rear side of the second protrusion.

A situation in which the mounting section is slidingly displaced toward the back of the head can be prevented by providing the first protrusion and the second protrusion. Moreover, the position of the head-mounted display can be adjusted in the eye width direction by rotating the head-mounted display, for example. Displacement of the head-mounted display in the pitch direction can be more effectively prevented by providing the third protrusion.

The head-mounted display may further comprise:

a first protrusion that is provided on a head-facing side surface of the second support target section of the mounting section;

a second protrusion that is provided on a head-facing side surface of the mounting section or a head-facing side surface of the arm section; and

a third protrusion that is provided on the head-facing side surface of the mounting section,

the second protrusion and the third protrusion may be disposed on a front side and a rear side of the first support target section, respectively.

The head of the user can be reliably held by providing the first protrusion, the second protrusion, and the third protrusion, so that displacement of the entire head-mounted display in the forward direction and the backward direction can be more reliably prevented.

In the head-mounted display,

the mounting section may be formed by an elastic member that holds each side of the head of the user.

According to the above feature, the head-mounted display is stably secured on the head of the user due to the inward biasing force applied by the elastic member that forms the mounting section.

The head-mounted display may further comprise:

a circuit board that is provided in a housing included in the arm section, an electronic part being mounted on the circuit board,

the circuit board may be disposed in the housing so that a surface direction of the circuit board extends along the one temporal region.

According to the above feature, the circuit board can be disposed in the housing included in the arm section by effectively utilizing an area adjacent to the temporal region of the user that is approximately linear when viewed from above. This makes it possible to sufficiently increase the length of the circuit board. Therefore, a larger number of electronic parts can be mounted on the circuit board.

In the head-mounted display,

the arm section may have a triangular vertical cross-sectional shape having a base that extends in a direction along the one temporal region.

The contact area of the arm section and the temporal region increases as a result of forming the arm section to have a triangular vertical cross-sectional shape having a base that extends in a direction along the one temporal region. This makes it possible to implement an improvement in the mounting (wearing) stability of the head-mounted display, and the like.

The head-mounted display may further comprise:

a first joint for folding the head-mounted display, the first joint being provided in an intermediate area between one end and the other end of the mounting section; and

a second joint for folding the head-mounted display, the second joint being provided in a connection area of the mounting section and the arm section.

Since each section separated by the first joint and the second joint has almost the same length, the head-mounted display can be folded into a compact shape (i.e., can be stored in a space-saving manner).

In the head-mounted display,

the head-mounted display may be bent at the second joint so that a direction from the second joint to the eye piece becomes parallel to a direction from the second joint to the first joint in a state in which the head-mounted display is bent at the first joint.

According to the above feature, the dimension (width) of the head-mounted display in a folded state can be reduced, so that the head-mounted display can be stored in a space-saving manner.

In the head-mounted display,

the head-mounted display may be bent at the second joint along a plane including the mounting section when the head-mounted display is bent at the first joint.

According to the above feature, the dimension (height) of the head-mounted display in a folded state can be reduced, so that the head-mounted display can be stored in a more space-saving manner.

The head-mounted display may further comprise;

a protection section that is provided at one end of the arm section, and protects the one of the right eye and the left eye,

the protection section may be formed by an elastic transparent member, and provided so that the protection section is positioned between the one of the right eye and the left eye and the eye piece when the user ears the head-mounted display.

The eye of the user can be protected by providing the protection section. Moreover, the display image light can be allowed to enter the eye of the user through the protection section formed by the elastic transparent member.

According to another embodiment of the invention, there is provided a head-mounted display comprising:

a mounting section that includes a first support target section, and is worn along a back of a head of a user so that the mounting section holds each side of the head of the user, the first support target section being supported by a base of one of a right ear and a left ear of the user; and

an arm section that is formed to extend forward from one end of the mounting section positioned on a side of the first support target section along one temporal region of the user, and includes an eye piece that faces one of a right eye and a left eye of the user, the eye piece being provided at a front-side end of the arm section,

an electronic part at least including a driver that drives a display section that generates a display image displayed on the eye piece being provided in a housing included in the arm section.

According to the head-mounted display, the first support target section of the mounting section is supported by the base of one of the right ear and the left ear of the user, and the mounting section is worn along the back of the head of the user so that the mounting section holds each side of the head of the user. The eye piece that faces one of the right eye and the left eye of the user is provided at the front-side end of the arm section that is formed to extend forward from one end positioned on the side of the first support target section of the mounting section.

The electronic parts such as the driver that drives the display section are provided in the housing included in the arm section. Therefore, the electronic parts can be provided in the arm section by effectively utilizing the arm section that is formed to extend forward from one end of the mounting section and has a sufficient length. This makes it possible to provide a large number of main electronic parts in the head-mounted display having a compact shape, for example. Moreover, the position of the center of gravity in the horizontal direction can be set to a position on the front side of the first support target section by providing the electronic parts in the arm section. This makes it possible to stably hold the eye piece, for example.

In the head-mounted display,

the arm section may include a first housing disposed on a side of the mounting section, and a second housing disposed on a side of the eye piece,

the electronic part may be provided in the first housing, and

an optical part that guides display image light from the display section to the eye piece may be provided in the second housing.

According to the above feature, the display image can be displayed on the display section by providing the electronic parts in the first housing, and causing the driver (i.e., electronic part) to drive the display section, and the display image light can be guided to the eye piece the optical part provided in the second housing.

In the head-mounted display,

the first housing may be provided in an area of the arm section that extends along the one temporal region, and

the second housing may be provided in an area of the arm section that extends from one end of the first housing to the eye piece.

According to the above feature, the electronic parts and the optical parts can be efficiently disposed corresponding to the shape of each section of the arm section.

The head-mounted display may further comprise:

a circuit board that is provided in the first housing, the electronic part being mounted on the circuit board,

the circuit board may be disposed in the first housing so that a surface direction of the circuit board extends along the one temporal region.

According to the above feature, the circuit board can be disposed in the housing included in the arm section by effectively utilizing an area adjacent to the temporal region of the user that is approximately linear when viewed from above. This makes it possible to sufficiently increase the length of the circuit board. Therefore, a larger number of electronic parts can be mounted on the circuit board.

In the head-mounted display,

the arm section may have a triangular vertical cross-sectional shape at a position of the first housing, the triangular vertical cross-sectional shape having a base that extends in a direction along the surface direction of the circuit board.

The contact area of the arm section and the temporal region increases as a result of forming the arm section to have a triangular vertical cross-sectional shape having a base that extends in a direction along the one temporal region. This makes it possible to implement an improvement in the mounting (wearing) stability of the head-mounted display, and the like.

In the head-mounted display,

a wireless module may be mounted on the circuit board as the electronic part,

the wireless module may be mounted on the circuit board at a position corresponding to a vertex of the triangular shape.

According to the above feature, the wireless module having a large height can be mounted on the circuit board by effectively utilizing the space at a position corresponding to the vertex of the triangular shape, for example.

The head-mounted display may further comprise:

a circuit board that is provided in the housing included in the arm section,

the electronic part may be disposed in the housing included in the arm section so that a surface direction of the circuit board extends along the one temporal region.

According to the above feature, the circuit board can be disposed, and a larger number of electronic parts can be mounted on the circuit board by effectively utilizing an area adjacent to the temporal region of the user that is approximately linear when viewed from above.

In the head-mounted display,

the arm section may have a triangular vertical cross-sectional shape at a position of the housing, the triangular vertical cross-sectional shape having a base that extends in a direction along the one temporal region.

The contact area of the arm section and the temporal region increases as a result of forming the arm section to have a triangular vertical cross-sectional shape having a base that extends in a direction along the one temporal region. This makes it possible to implement an improvement in the mounting (wearing) stability of the head-mounted display, and the like.

In the head-mounted display,

the driver that drives the display section, a wireless module, and a secondary battery may be provided in the housing included in the arm section as the electronic part.

According to the above feature, necessary electronic parts such as the driver, the wireless module, and the secondary battery can be provided in the arm section, so that a head-mounted display having a compact shape can be implemented.

In the head-mounted display,

an angle θ formed by a first direction and a second direction may be equal to or greater than 145°, the first direction being a direction from the first support target section to a rear end of the mounting section, and the second direction being a direction from the first support target section to the eye piece provided on the arm section when viewed from the side of the one temporal region.

According to the above feature, the mounting section does not interfere with the back of the neck even if the user moves his head around. This makes it possible to stably hold the eye piece in front of the visual axis of the user.

Exemplary embodiments of the invention are described below. Note that the following exemplary embodiments do not in any way limit the scope of the invention laid out in the claims. Note also that all of the elements of the following exemplary embodiments should not necessarily be taken as essential elements of the invention.

1. Configuration Example

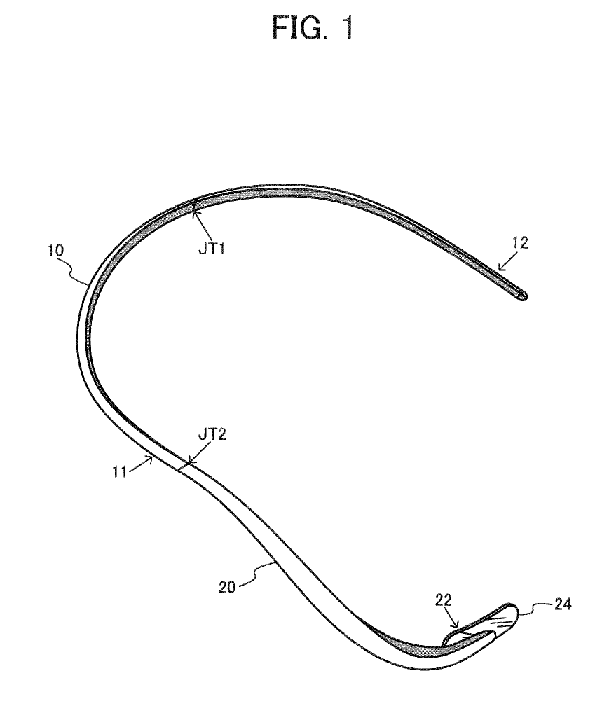

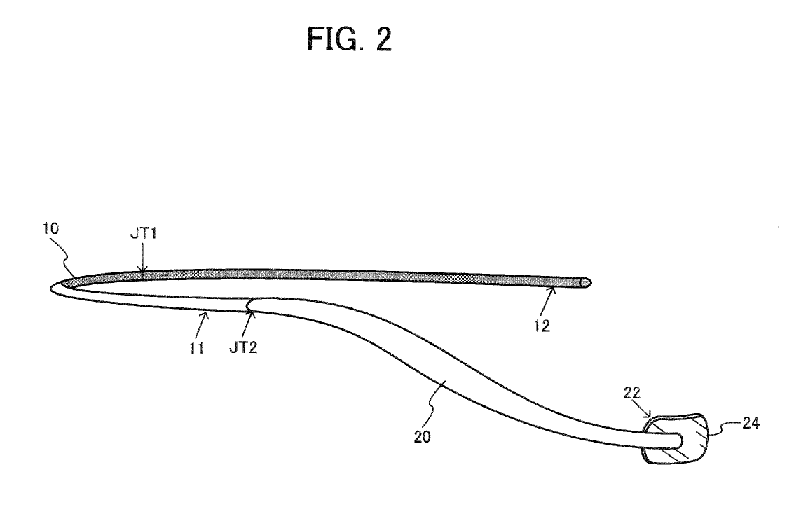

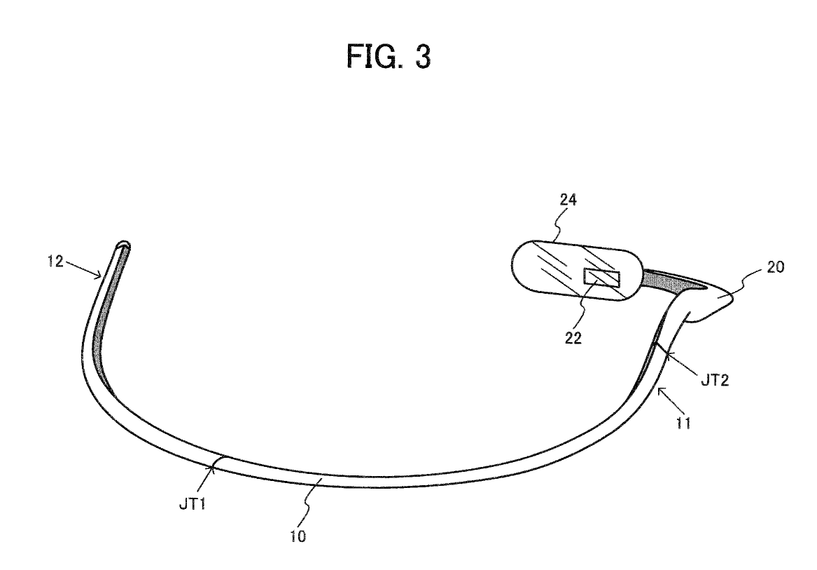

FIGS. 1 to 3 illustrate a configuration example of a head-mounted display (HMD) (head-wearable display or eyeglass-type display) according to one embodiment of the invention. FIG. 1 is a perspective view of the HMD, FIG. 2 is right side view of the HMD, and FIG. 3 is a rear view of the HMD. The HMD according to one embodiment of the invention includes a mounting section 10 and an arm section 20.

The mounting section 10 is a member that is used to secure (hold) the entire HMD on the head of the user, and is worn along the back of the head of the user. Specifically, the mounting section 10 has a curved rod-like external shape. When the user wears the HMD, the mounting section 10 extends from one ear to the other along the back of the head, and holds each side of the head of the user.

The mounting section 10 includes a first support target section 11. The first support target section 11 is supported by the base of one of the right ear and the left ear (e.g., the upper part of the base of the ear) of the user. The mounting section 10 preferably further includes a second support target section 12. The second support target section 12 is supported by the base of the other of the right ear and the left ear (e.g., the upper part of the base of the ear) of the user. In the example shown in FIGS. 1 to 3, the first support target section 11 is supported by the right ear of the user, and the second support target section 12 is supported by the left ear of the user. When an eye piece 22 is positioned in front of the left eye of the user, the first support target section 11 is supported by the left ear of the user, and the second support target section 12 is supported by the right ear of the user. When the HMD is stably supported due to the inward biasing force applied by the mounting section 10, for example, the mounting section 10 may not include the second support target section 12.

The mounting section 10 (holding section) is worn along the back of the head of the user so that the mounting section 10 holds each side of the head (e.g., ear) of the user. Specifically, the mounting section 10 is formed by an elastic member (metal member or resin member having resilient properties) that has a semicircular shape, and holds each side of the head of the user, for example. More specifically, the mounting section 10 has resilient properties in the diametrical direction. The HMD is secured (mounted) on the head of the user due to the inward (radial) biasing force applied by the elastic member. Note that the semicircular shape of the mounting section 10 need not necessarily be part of a true circle. The mounting section 10 may have an arbitrary shape (e.g., elliptical shape) as long as the mounting section 10 can be worn around the head of the user, and may have an approximately semicircular shape.

The arm section 20 is an arm-shaped member that holds electronic parts, optical parts, the eye piece 22, a protection section 24, and the like, and has a rod-like external shape. Specifically, the arm section 20 includes electronic parts (e.g., display section driver device, wireless module, video converter, and display section) and optical parts (e.g., ocular optical system), as described later. The eye piece 22 that emits display image light (image light) and the protection section 24 are provided at the end of the arm section 20.

The arm section 20 is formed to extend forward from one end (position indicated by JT2) of the mounting section 10 positioned on the side of the first support target section 11 along one temporal region of the user. In the example shown in FIGS. 1 to 3, the arm section 20 is formed to extend along the right temporal region of the user. The eye piece 22 (display window) that faces the right eye or the left eye of the user is provided at the front-side end of the arm section 20 (i.e., the front side when the user wears the HMD). In the example shown in FIGS. 1 to 3, the eye piece 22 is provided to face the right eye of the user. Note that the eye piece 22 may be provided to face the left eye of the user.

Specifically, the arm section 20 is connected to one end of the mounting section 10, includes necessary electronic parts (electrical components) and part or the entirety of the ocular optical system, and has the eye piece 22 at its end. The arm section 20 is formed to extend forward from the right ear or left ear along the temporal region when the user wears the HMD, and the eye piece 22 is positioned to cross the visual axis of the eyeball of the user. More specifically, a circuit board on which electronic parts are mounted is provided inside a housing included in the arm section 20 (described later). The circuit board is disposed so that the surface (planar) direction (i.e., the direction along the surface) coincides with the direction along one temporal region (e.g., right temporal region) of the user. The arm section 20 has a triangular vertical cross-sectional shape having a base that extends in the direction along one temporal region of the user.

The HMD shown in FIGS. 1 to 3 includes a first joint JT1 and a second joint JT2 for folding the HMD. The first joint JT1 is provided in an intermediate area (e.g., center) between one end (i.e., the end on the side of the first support target section 11) and the other end (i.e., the end on the side of the second support target section 12) of the mounting section 10. The second joint JT2 is provided in the connection area of the mounting section 10 and the arm section 20. The first joint JT1 and the second joint JT2 can be bent using a known joint mechanism (not shown).

The length from the end of the mounting section 10 to the first joint JT1, the length from the first joint JT1 to the second joint JT2, and the length from the second joint JT2 to the end of the arm section 20 can be made almost equal by providing the first joint JT1 in the intermediate area of the mounting section 10, and providing the second joint JT2 in the connection area of the mounting section 10 and the arm section 20. Therefore, the HMD can be stored in a space-saving manner by folding the HMD at the first joint JT1 and the second joint JT2.

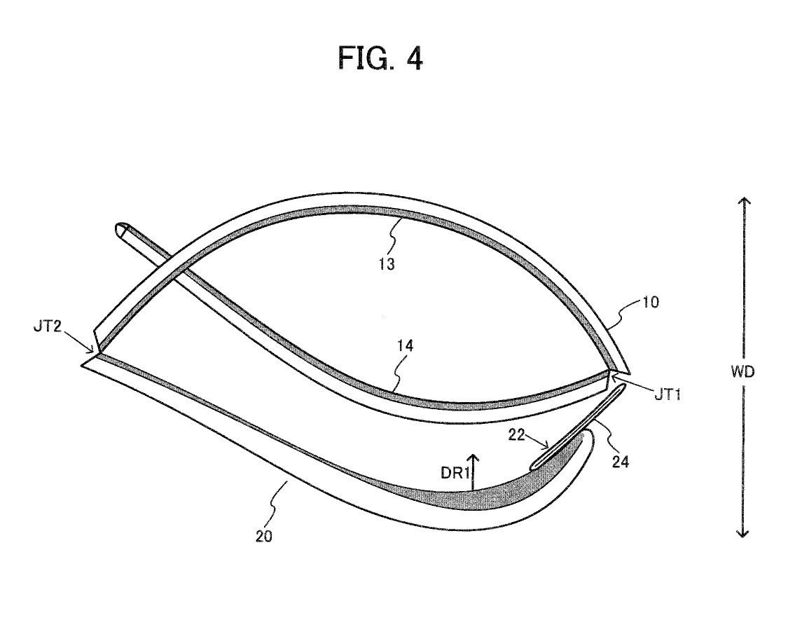

FIG. 4 is a plan view showing the HMD in a folded state. The folded state shown in FIG. 4 is implemented by bending the HMD at the first joint JT1 and the second joint JT2. For example, the HMD is bent inward (i.e., the direction in which a first portion 13 and a second portion 14 of the mounting section 10 approach each other) at the first joint JT1. The HMD is bent inward (i.e., the direction in which the mounting section 10 (13, 14) and the arm section 20 approach each other) at the second joint JT2.

More specifically, the HMD is bent at the second joint JT2 in a direction DR1 in which the direction from the second joint JT2 to the eye piece 22 becomes parallel to the direction from the second joint JT2 to the first joint JT1 in a state in which the HMD is bent at the first joint JT1 (i.e., the HMD is bent inward). Specifically, the HMD is bent (in the direction DR1) at the second joint JT2 so that the direction from the second joint JT2 to the first joint JT1 and the direction from the second joint JT2 to the eye piece 22 become parallel to each other. This makes it possible to reduce a width WD shown in FIG. 4 when folding the HMD, so that the HMD can be stored in a space-saving manner.

The HMD is bent at the second joint JT2 along a plane including the mounting section 10 when the HMD is bent at the first joint JT1. Specifically, the HMD is bent along a plane including the first portion 13 and the second portion 14 of the mounting section 10. That is, the HMD is bent at the second joint JT2 in the direction parallel to the sheet. This makes it possible to reduce the width in the height direction perpendicular to the sheet when folding the HMD, so that the HMD can be stored in a more space-saving manner.

Although the HMD shown in FIG. 1 includes the first joint JT1 and the second joint JT2, a modification in which such a joint is not provided is also possible. For example, the mounting section 10 and the arm section 20 may be integrally formed. A modification in which three or more joints are provided is also possible.

The HMD shown in FIGS. 1 to 3 includes the protection section 24 that protects the eye of the user. Specifically, the protection section 24 that protects one eye (e.g., right eye) of the user is provided at one end (i.e., the end on the side of the eye piece 22) of the arm section 20 in order to prevent a situation in which the end of the arm section 20 comes in direct contact with the eye of the user.

The protection section 24 is formed by an elastic transparent member (elastic transmission member), and has a tabular shape, for example. The protection section 24 is provided so that the protection section 24 is positioned between one eye (e.g., right eye) of the user and the eye piece 22 when the user wears the HMD (see FIG. 3). Specifically, the protection section 24 is provided at a position at which the display image light from the eye piece 22 passes through the transparent protection section 24 and enters one eye of the user.

The protection section 24 is formed by an elastic transparent member such as an elastomer (transparent flexible polymer). Therefore, the protection section 24 rarely breaks due to external force, can be reduced in thickness, and rarely damages the eye of the user with the edge. Moreover, the protection section 24 has a reduced weight, is safe, and prevents contamination of the eye piece 22. Since the surface of the protection section 24 that faces the eye of the user is flat, the protection section 24 can be easily cleaned, and rarely breaks during storage.

The following functions and performance (wearability) are ideally desired for the HMD.

The eye piece can be stably held in front of the visual axis even if the user moves his head around. (2) The HMD is beautifully-designed. (3) The HMD can be stored in a space-saving manner. (4) The HMD can be easily attached and detached, and is handy. (5) The eye piece can be aligned depending on the individual variation in the shape of the face (e.g., the width and the height of the eyes). (6) The HMD can be worn over glasses. (7) The HMD has a simple configuration, and is durable. (8) The HMD can be easily designed to be dustproof and waterproof.

The HMD according to one embodiment of the invention is configured so that the eye piece 22 can be stably held in front of the visual axis of the user even if the user moves his head around, as described in detail later. The HMD according to one embodiment of the invention is beautifully-designed (see FIGS. 1 to 3) and can be stored in a space-saving manner (see FIG. 4). The HMD according to one embodiment of the invention can be easily attached and detached, and is handy. Specifically, the HMD can be carried in a state in which the HMD is worn around the neck, and the user can immediately use the HMD when the user wants to use the HMD. The eye piece of the HMD according to one embodiment of the invention can be aligned depending on the individual variation in the shape of the face (e.g., the width and the height of the eyes), as described in detail later. The HMD according to one embodiment of the invention can be worn over glasses, has a simple configuration, and is durable. The HMD according to one embodiment of the invention can be easily designed to be dustproof and waterproof. Specifically, the mounting section 10 and the arm section 20 of the HMD are integrally formed to have a flat and smooth surface, and only the first joint JT1 and the second joint JT2 are used to connect the elements (see FIGS. 1 to 3). Therefore, the HMD is durable, and can be easily designed to be dustproof and waterproof For example, since wires or the like need not be provided in the joint JT2, as described in detail later, the HMD can be easily designed to be dustproof and waterproof.

The mounting section 10 of the HMD according to one embodiment of the invention has a semicircular shape. Therefore, the HMD can be mounted on the head of the user at an arbitrary position around the center axis (rotation axis) of the circle, and the position of the ocular optical system (eye piece) can be aligned in the horizontal direction when viewed from the front side.

The HMD according to one embodiment of the invention is worn so that the mounting section 10 is positioned from one ear to the other along the back of the head. Therefore, the mounting section 10 is supported by two fulcrums, and the HMD can be mounted on the head at an arbitrary position around an axis (rotation axis) that passes through the fulcrums. This makes it possible to align the ocular optical system in the vertical direction when viewed from the front side.

The arm section 20 is generally formed in the shape of an arm that extends from the ear of the user to the front side or the side of the eye of the user. Therefore, since the arm section 20 (narrow housing) can have a sufficient length, the arm section 20 has an internal volume sufficient to accommodate electronic parts (electrical components) and optical parts. The arm section 20 provides the HMD with a beautiful form, and can hold the eye piece 22 directly in front of the pupil of the eye of the user.

Since the first joint JT1 is provided around the center of the semicircular mounting section 10, and the second joint JT2 is provided in the connection area of the mounting section 10 and the arm section 20, the entire HMD can be divided into three approximately equal parts using the joints JT1 and JT2. Therefore, the dimensions of the HMD in a folded state can be reduced, so that the HMD can be stored in a space-saving manner. The joint does not overlap the housing (i.e., housing that accommodates an electronic part) as a result of providing the second joint JT2 in the connection area of the mounting section 10 and the arm section 20. Therefore, the transmission system can be formed using a rigid circuit board (electronic circuit board). Specifically, when wires connected to the electronic parts are provided in the joint JT2, it is necessary to use a flexible cable. In this case, since the bending angle must be increased in order to prevent breakage, the size of the joint increases. Moreover, it is difficult to take dustproof/waterproof measures due to an opening formed to bring the cable into the housing. The HMD according to one embodiment of the invention can solve the above problems.

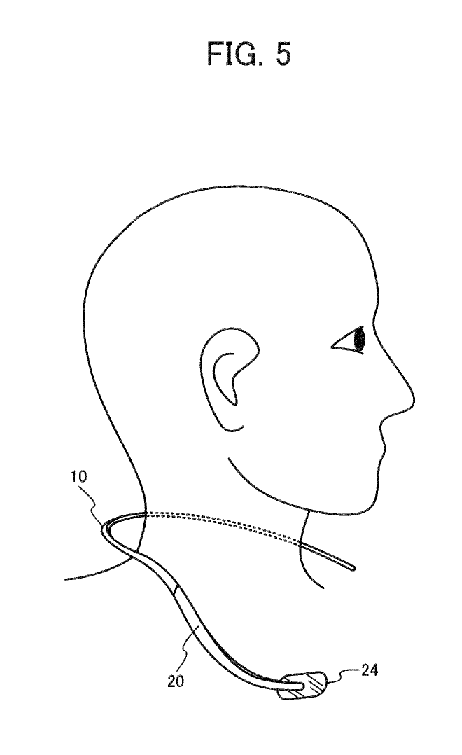

The HMD according to one embodiment of the invention is configured so that the arm section 20 is secured on one end of the mounting section 10, and the eye piece 22 is provided at the end of the arm section 20. Specifically, since the HMD is not closed, the HMD can be easily worn around (or removed from) the neck (see FIG. 5).

The HMD according to one embodiment of the invention thus implement the functions and the performance (wearability) that are ideally desired for the HMD.

2. Center-of-Gravity Position

In one embodiment of the invention, the position of the center of gravity of the HMD in the horizontal direction is set to a position on the front side of the first support target section shown in FIGS. 1 to 3, or the position of the first support target section 11 (a position around the first support target section) when viewed from the side of one temporal region of the user. The position of the center of gravity of the HMD in the horizontal direction is preferably set to a position below the first support target section, or the position of the first support target section 11 (a position around the first support target section) when viewed from the side of one temporal region of the user.

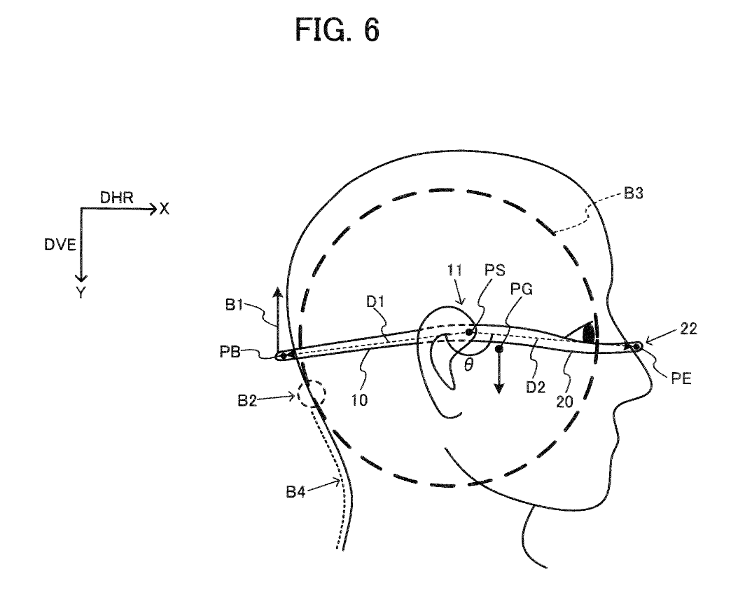

For example, reference symbol PS in FIG. 6 indicates a position obtained by projecting the position of the first support target section 11 corresponding to the upper part of the base of the ear (right ear) of the user when viewed from the side of one temporal region (right temporal region in FIG. 6) of the user. Likewise, reference symbols PE, PB, and PG respectively indicate positions obtained by projecting the position of the eye piece 22, the position of the rear end of the mounting section 10, and the center-of-gravity position when viewed from the side of one temporal region of the user.

In FIG. 6, the direction from the first support target section 11 (PS) to the rear end (PB) of the mounting section 10 when viewed from the side of one temporal region of the user is referred to as a first direction D1 (first straight line). The direction from the first support target section 11 (PS) to the eye piece 22 (PE) provided on the arm section 20 is referred to as a second direction D2 (second straight line). The angle formed by the first direction D1 and the second direction D2 is referred to θ.

The angle θ corresponds to the angle formed by a straight line that connects the upper part of the base of the ear of the user and the rear end of the mounting section 10 (surface that comes in contact with the back of the head) and a straight line that connects the upper part of the base of the ear and the center of the eyeball. Specifically, since the first support target section 11 comes in contact with the base of the ear, the position PS of the first support target section 11 is considered to be identical with the position of the base of the ear. Since the position PE of the eye piece is located on the visual axis that passes through the center of the eyeball, the position PE of the eye piece is approximately located on a straight line that connects the position PS and the center of the eyeball. A minor angle (θ) and a major angle (360°-θ) are formed by the first direction D1 and the second direction D2 shown in FIG. 6. The angle θ refers to an angle on the lower side with respect to the user. For example, when θ<180°, the angle θ formed by the first direction D1 and the second direction D2 is a minor angle. When 180°<θ<220°, the angle θ is a major angle. In other words, when the eye piece 22 is positioned in front of the right eye of the user (see FIG. 6), the angle θ is an angle measured counterclockwise from the first direction D1 to the second direction D2 when viewed from the side of the right temporal region. When the eye piece 22 is positioned in front of the left eye of the user, the angle θ is an angle measured clockwise from the first direction D1 to the second direction D2 when viewed from the side of the left temporal region.

As shown in FIG. 6, the position of the center of gravity PG of the HMD in the horizontal direction is set to a position on the front side of the position PS of the first support target section 11 (or the position on the first support target section 11 when viewed from the side of one temporal region (right temporal region) of the user. Specifically, the position of the center of gravity PG in the horizontal direction is set to a position on the front side of (or around) the ear of the user. For example, the position of the center of gravity PG of the HMD in the horizontal direction can be set to a position on the front side of the position PS of the first support target section 11 by incorporating heavy electronic parts and optical parts in the arm section 20.

As shown in FIG. 6, when the axis along a horizontal direction DHR is referred to as an X-axis, the position of the center of gravity PG in the horizontal direction is indicated by the X-coordinate value of the center of gravity PG. Therefore, when the positive direction along the X-axis is the forward direction, the expression “the position of the center of gravity PG in the horizontal direction is set to a position on the front side of the position PS of the first support target section 11” means that the X-coordinate value of the center of gravity PG is larger than the X-coordinate value of the position PS. The expression “the position of the center of gravity PG in the horizontal direction is set to the position PS” means that the X-coordinate value of the center of gravity PG (almost) coincides with the X-coordinate value of the position PS.

The rear end of the mounting section 10 does not move downward due to gravity by setting the center of gravity PG as shown in FIG. 6. Specifically, when the position of the center of gravity PG in the horizontal direction is set to a position on the front side of the HMD, the rear end of the mounting section 10 is forced to move upward (see B1 in FIG. 6). Therefore, it is unnecessary to set the contact area of the back of the head and the HMD to a position below the position indicated by B2 by setting the center of gravity PG as shown in FIG. 6.

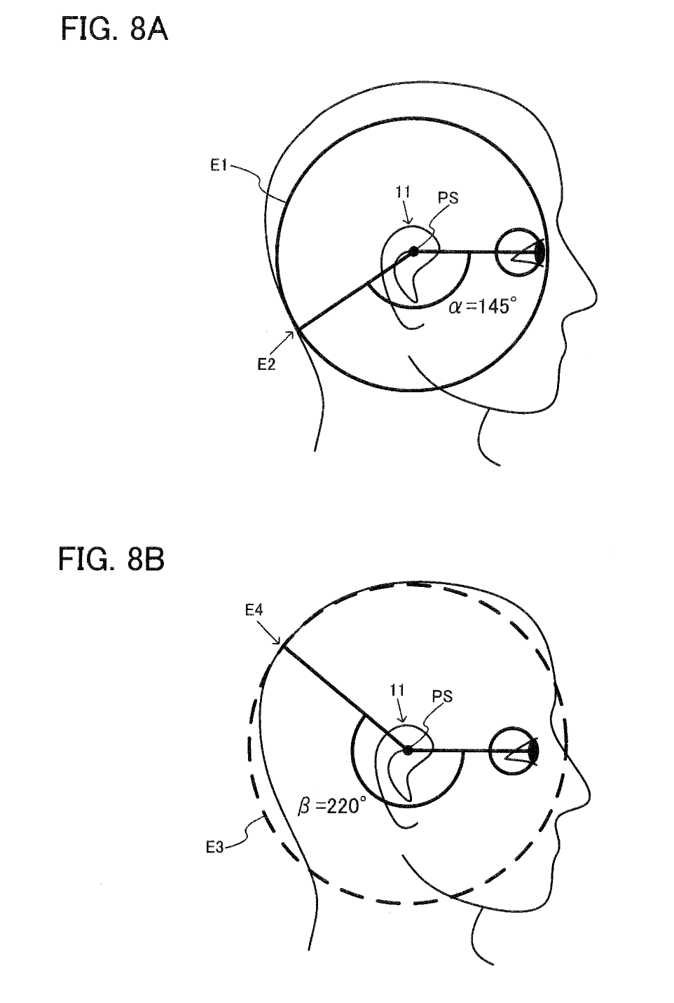

For example, reference symbol B3 in FIG. 6 indicates an inscribed circle to the section of the back of the head drawn around the position PS of the ear of the user. Reference symbol B2 indicates a position where the inscribed circle comes in contact with the back of the head. As described in detail later with reference to FIG. 8A, the angle formed by a line segment that extends from the ear of the user to the position indicated by B2 and a line segment that extends from the ear of the user to the center of the eyeball is about 145° when the user has a standard head shape. Therefore, the position indicated by B2 corresponds to the position at which the angle θ formed by the first direction D1 and the second direction D2 shown in FIG. 6 is 145°.

When the position of the center of gravity PG in the horizontal direction is set to a position on the rear side of the position PS, it is necessary to set the contact area of the back of the head and the HMD to a position below the position indicated by B2. Specifically, if the contact area of the back of the head and the HMD is set to a position below the position indicated by B2, the rear end of the HMD is supported by the back of the neck (i.e., the rear end of the HMD does not move downward) even if the rear end of the HMD is attracted downward due to gravity.

On the other hand, the rear end of the HMD is not attracted downward due to gravity when the position of the center of gravity PG in the horizontal direction is set to a position on the front side of the position PS (see FIG. 6). This makes it unnecessary to set the contact area of the back of the head and the HMD to a position below the position indicated by B2. When the contact area of the back of the head and the HMD is set to a position above the position indicated by B2, the rear end of the mounting section 10 is not caught by the back of the neck of the user even if the user moves his head upward and downward, so that a situation in which the eye piece 22 is displaced can be prevented.

Therefore, the position of the center of gravity PG in the horizontal direction is set to a position on the front side of the position PS, and the angle θ formed by the first direction D1 and the second direction D2 is set to be equal to or greater than 145°. Specifically, the angle θ is structurally (mechanically) fixed so that the angle θ is equal to or greater than 145°. Since the position indicated by B2 shown in FIG. 6 is a position at which the angle θ is 145°, the contact area of the back of the head and the HMD is set to a position above the position indicated by B2 by setting the angle θ to be equal to or greater than 145°. The rear end of the HMD is forced to move upward due to gravity as a result of setting the position of the center of gravity PG in the horizontal direction to a position on the front side of the position PS, so that the HMD is held in a stable manner. This makes it possible to effectively prevent a situation in which the eye piece 22 is displaced even if the user moves his head upward and downward.

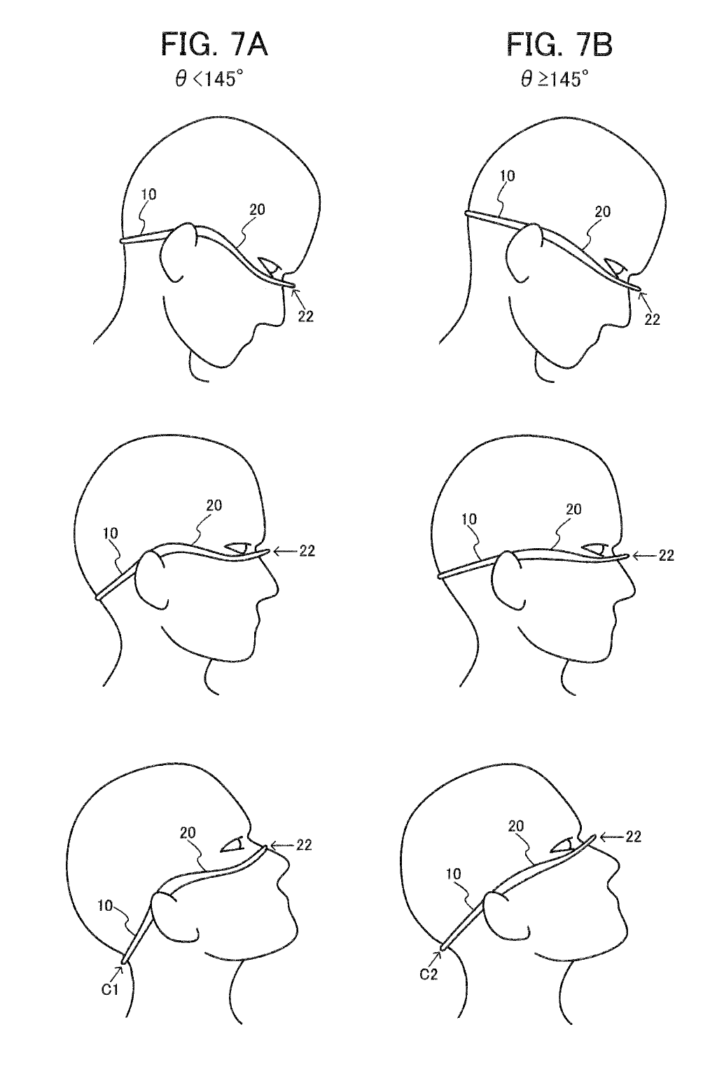

FIG. 7A shows an example in which the angle θ is less than 145°. As shown in FIG. 7A, when the angle θ is less than 145°, the rear end of the mounting section 10 is caught by the back of the neck of the user (see C1) when the user moves his head upward and downward, so that the eye piece 22 is displaced. This makes it impossible to stably hold the eye piece 22 in front of the visual axis of the user when the user moves his head upward and downward.

FIG. 7B shows an example in which the angle θ is equal to or greater than 145°. As shown in FIG. 7B, when the angle θ is equal to or greater than 145°, the rear end of the mounting section 10 is not caught by the back of the neck of the user (see C2) even if the user moves his head upward and downward, so that a situation in which the eye piece 22 is displaced can be prevented. This makes it possible to stably hold the eye piece 22 in front of the visual axis of the user even if the user moves his head upward and downward.

In one embodiment of the invention, the angle θ is preferably equal to or greater than 145° and less than 220°. For example, the angle θ is structurally (mechanically) fixed so that the angle θ is equal to or greater than 145° and less than 220°. As described in detail later with reference to FIG. 8B, the rear end (PB) of the HMD is caught by the back of the head when the angle θ is less than 220°, so that displacement of the rear end (PB) of the HMD in the direction indicated by B1 in FIG. 6 can be prevented. However, displacement of the rear end (PB) of the HMD in the direction indicated by B1 in FIG. 6 cannot be prevented when the angle θ is equal to or greater than 220°.

In one embodiment of the invention, the angle θ is preferably equal to or greater than 145° and less than 180°. When the angle θ is less than 180°, the position of the center of gravity PG in the vertical direction can be set to a position below the position PS of the first support target section 11. The mounting (wearing) stability of the HMD can be improved by setting the position of the center of gravity PG in the vertical direction to a position below the position PS of the first support target section 11 that functions as a fulcrum, as is clear from the principle of a balancing toy.

As shown in FIG. 6, when the axis along a vertical direction DVE is referred to as a Y-axis, the position of the center of gravity PG in the vertical direction is indicated by the Y-coordinate value of the center of gravity PG. Therefore, when the positive direction along the Y-axis is the downward direction, the expression “the position of the center of gravity PG in the vertical direction is set to a position below the position PS of the first support target section 11” means that the Y-coordinate value of the center of gravity PG is larger than the Y-coordinate value of the position PS. The expression “the position of the center of gravity PG in the vertical direction is set to the position PS” means that the Y-coordinate value of the center of gravity PG (almost) coincides with the Y-coordinate value of the position PS.

FIGS. 8A and 8B are views showing an average head shape according to statistics. Reference symbol E1 in FIG. 8A indicates an inscribed circle to the section of the back of the head, and reference symbol E2 indicates the contact point of the inscribed circle and the back of the head. In this case, an angle α formed by a line that extends from the ear to the contact point indicated by E2 and a line that extends from the ear to the center of the eyeball is 145°. Since the angle α corresponds to the angle θ shown in FIG. 6, the rear end of the HMD comes in contact with the back of the head when the angle θ is set to be equal to or greater than 145°, so that upward displacement of the rear end of the HMD can be prevented. Therefore, the eye piece 22 can be stably held in front of the visual axis of the user by setting the position of the center-of-gravity to a position on the front side of the position PS, for example. Specifically, when the angle θ is set to be equal to or greater than 145°, the mounting section 10 is positioned above the back of the neck of the user when the user wears the HMD in a state in which the eye piece 22 is positioned in front of the visual axis of the user. Therefore, the mounting section 10 does not interfere with the back of the neck even if the user moves his head upward and downward, so that the eye piece 22 is stably held relative to the face of the user.

Reference symbol E3 in FIG. 8B indicates a circumscribed circle to the section of the back of the head, and reference symbol E4 indicates the contact point of the circumscribed circle and the back of the head. In this case, an angle β formed by a line that extends from the ear to the contact point indicated by E4 and a line that extends from the ear to the center of the eyeball is 220°. The angle β corresponds to the angle θ shown in FIG. 6. If the position of the rear end of the mounting section 10 of the HMD is higher than the position indicated by E4, the eye piece 22 provided at the end of the arm section 20 may be displaced downward around the ear when the position of the center of gravity PG is set to a position on the front side of the position PS. This makes it difficult to stably hold the eye piece 22 in front of the visual axis of the user. Specifically, the angle β (=220°) is a limit value at which the HMD is supported by the back of the head and does not move downward when the position of the center of gravity PG is set to a position on the front side of the position PS. Therefore, the angle θ corresponding to the angle β is preferably equal to or greater than 145° and less than 220°.

If the angle θ is less than 180°, the position of the center of gravity PG in the vertical direction can be set to a position below the position PS, so that the HMD is held in a stable manner. This makes it possible to improve the mounting (wearing) stability. Therefore, the angle θ is more preferably equal to or greater than 145° and less than 180°.

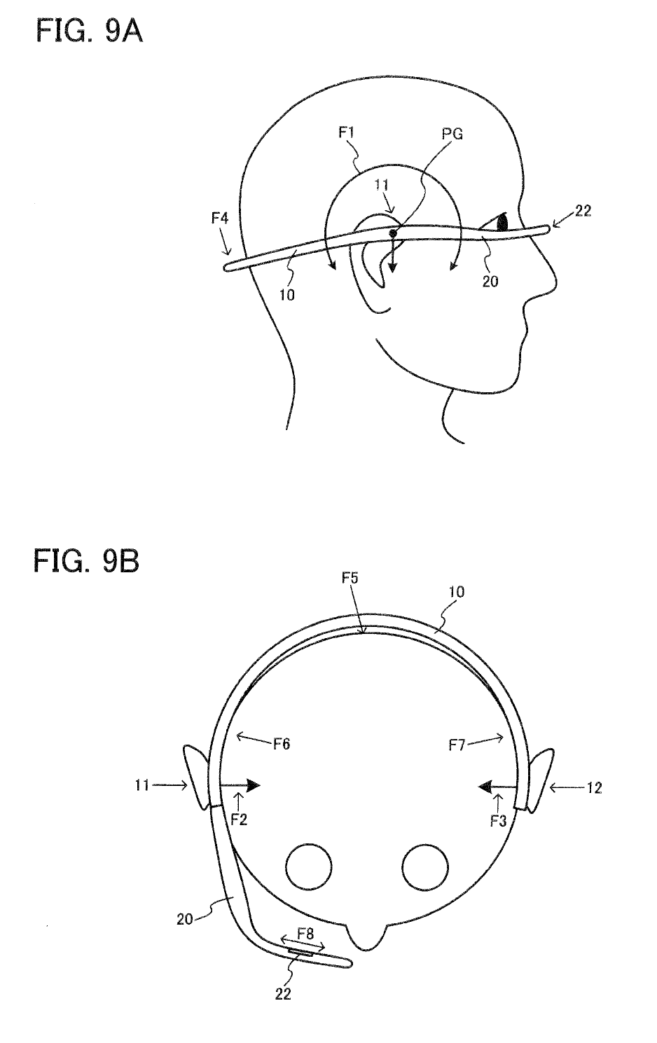

An example in which the position of the center of gravity PG of the HMD in the horizontal direction is set to a position on the front side of the first support target section 11 (on the front side with respect to the user who wears the HMD) has been described above. Note that the position of the center of gravity PG in the horizontal direction may be set to the position of the first support target section 11 (see FIG. 9A). Specifically, the center of gravity PG may be set at a position around the ear of the user.

When the center of gravity PG is set at a position around the ear of the user, the rotational moment in the rotation direction (see F1 in FIG. 9A) is small. Therefore, rotation of the HMD in the rotation direction indicated by F1 is sufficiently prevented due to a friction force that occurs between the HMD and the head.

Specifically, as indicated by F2 and F3 in FIG. 9B, the biasing force due to the elastic member is applied inward from the semicircular shape of the mounting section 10, so that each temporal region of the user is pressed by the mounting section 10, and a friction force occurs between the HMD and the head. Since rotation of the HMD in the rotation direction indicated by F1 is prevented due to the friction force, the rear end of the mounting section 10 need not necessarily come in contact with the back of the head of the user (see F4 in FIG. 9A and F5 in FIG. 9B). The HMD is affected by the hairstyle of user to only a small extent if the rear end of the mounting section 10 is shaped so that the rear end of the mounting section 10 does not come in contact with the back of the head of the user.

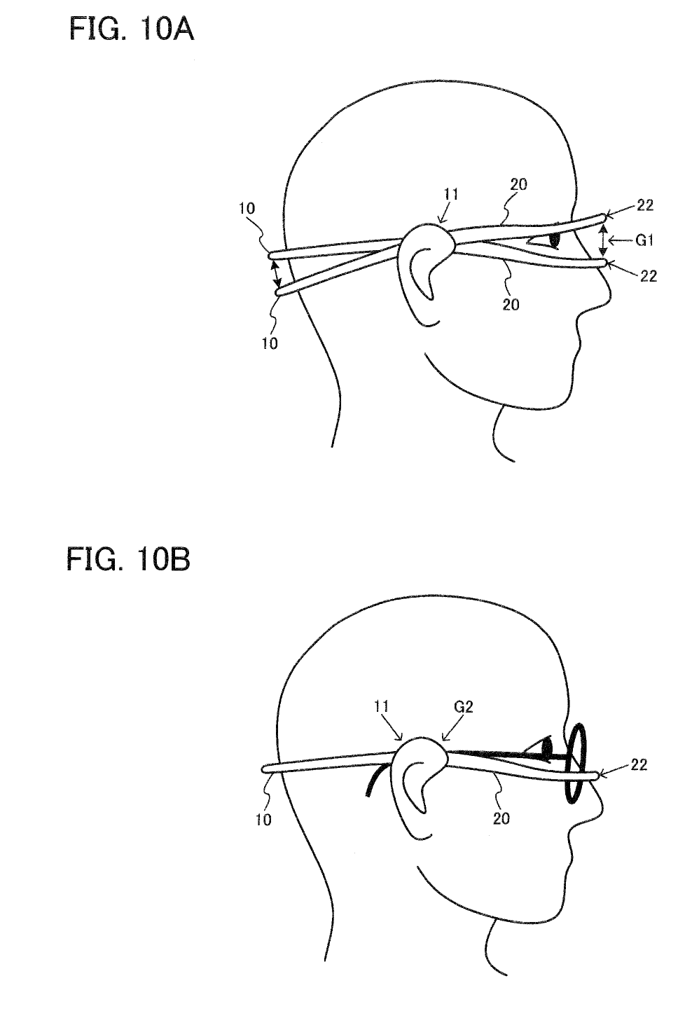

The HMD according to one embodiment of the invention is configured so that the position of the eye piece 22 (ocular optical system) can be adjusted in the vertical direction around the ear of the user (first support target section 11) (fulcrum) (see G1 in FIG. 10A). Specifically, the position of the eye piece 22 can be easily adjusted in the pitch direction.

Since the shape of the back of the head of the user is approximately circular (see F6 and F7 in FIG. 9B), the position of the eye piece 22 can be adjusted in the horizontal direction (i.e., the eye width direction) (see F8).

The HMD according to one embodiment of the invention is configured so that the HMD interferes with the temple of glasses worn by the user only in the area of the ear (see G2 in FIG. 10B). Therefore, the user can wear the HMD over the glasses. Since the interference in the area of the ear presses the temple toward the head at one point, deformation of the frame of the eyeglasses, or displacement (change in position) of the eyeglasses can be prevented.

As described above, the HMD according to one embodiment of the invention can stably hold the eye piece in front of the visual axis even if the user moves his head around, allows an adjustment of the position of the eye piece corresponding to the shape of the face of each user, and can be worn over glasses.

3. Protrusion

In one embodiment of the invention, it is preferable to provide a protrusion (bump) on the head-facing side surface (inner side surface) of the HMD. For example, the protrusion is provided on at least one of the head-facing side surface of the second support target section 12 of the mounting section 10, the head-facing side surface of the first support target section 11 of the mounting section 10, and the head-facing side surface of the arm section 20 on the side of the first support target section 11. Note that the head-facing side surface refers to the side surface of the HMD that faces the head of the user. The protrusion has a curved protrusion shape (bump shape), for example.

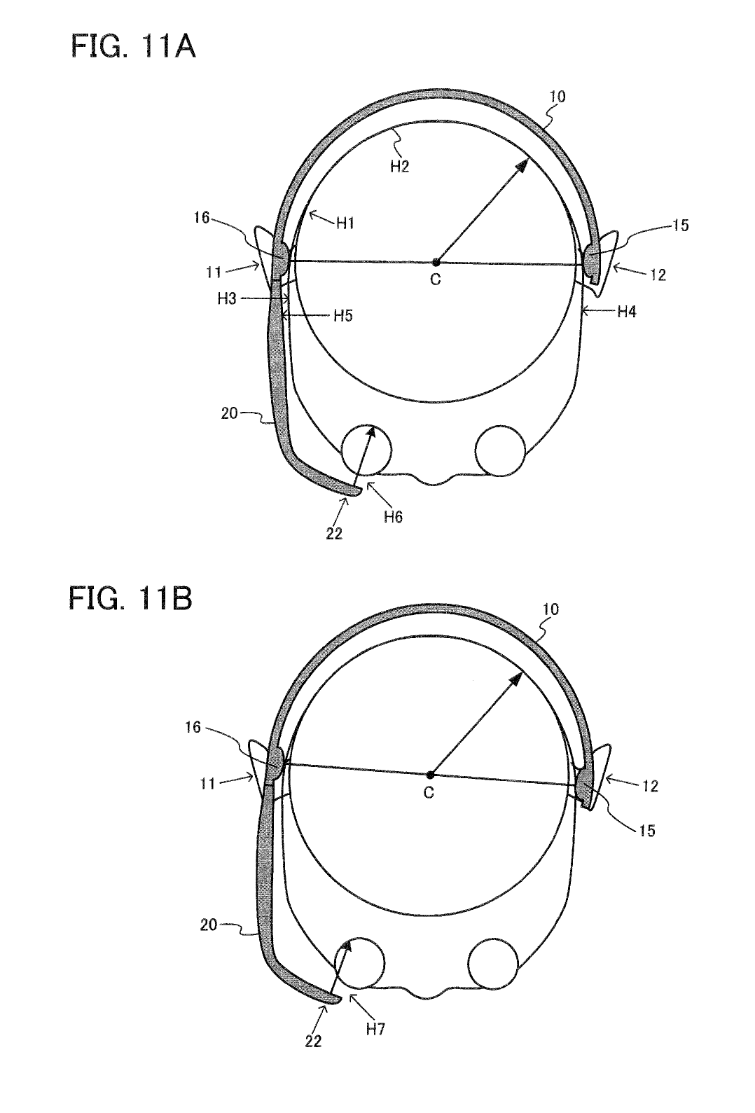

As shown in FIG. 11A, the cross-sectional shape of the back of the head on the rear side of the ears along a plane that passes through the eyes and the ears of the user is approximately circular (see H1), and the center C of a circle indicated by H2 is positioned around the center between the ears. Each temporal region on the front side of the ears is approximately linear when viewed from above (see H3 and H4).

In FIG. 11A, a first protrusion 15 and a second protrusion 16 are provided on the HMD. The first protrusion 15 is provided on the head-facing side surface of the second support target section 12 of the mounting section 10. In FIG. 11A, since the eye piece 22 is disposed in front of the right eye of the user when the user wears the HMD, the first protrusion 15 is provided around the left ear of the user. When the eye piece 22 is disposed in front of the left eye of the user, the first protrusion 15 is provided around the right ear of the user.

The second protrusion 16 is provided on the head-facing side surface of the first support target section 11 of the mounting section 10. In FIG. 11A, since the eye piece 22 is disposed in front of the right eye of the user, the second protrusion 16 is provided around the right ear of the user. When the eye piece 22 is disposed in front of the left eye of the user, the second protrusion 16 is provided around the left ear of the user.

Note that the second protrusion 16 may be provided on the head-facing side surface of the arm section 20. Specifically, the second protrusion 16 may be provided on the head-facing side surface of the arm section 20 on the side of the first support target section 11 (i.e., the position indicated by H5).

When the first protrusion 15 and the second protrusion 16 are provided on the mounting section 10 around the ears (see FIG. 11A), since the first protrusion 15 and the second protrusion 16 are positioned on either side of the center C of the circle indicated by H2, a situation in which the mounting section 10 is slidingly displaced toward the back of the head can be prevented. Moreover, since the HMD can be rotated around the center C of the circle of H2 (see FIG. 11B), the position of the HMD can be adjusted in the eye width direction (see H6 and H7) (i.e., alignment corresponding to each user can be implemented). Although two protrusions are provided in FIGS. 11A and 11B, only one protrusion may be provided.

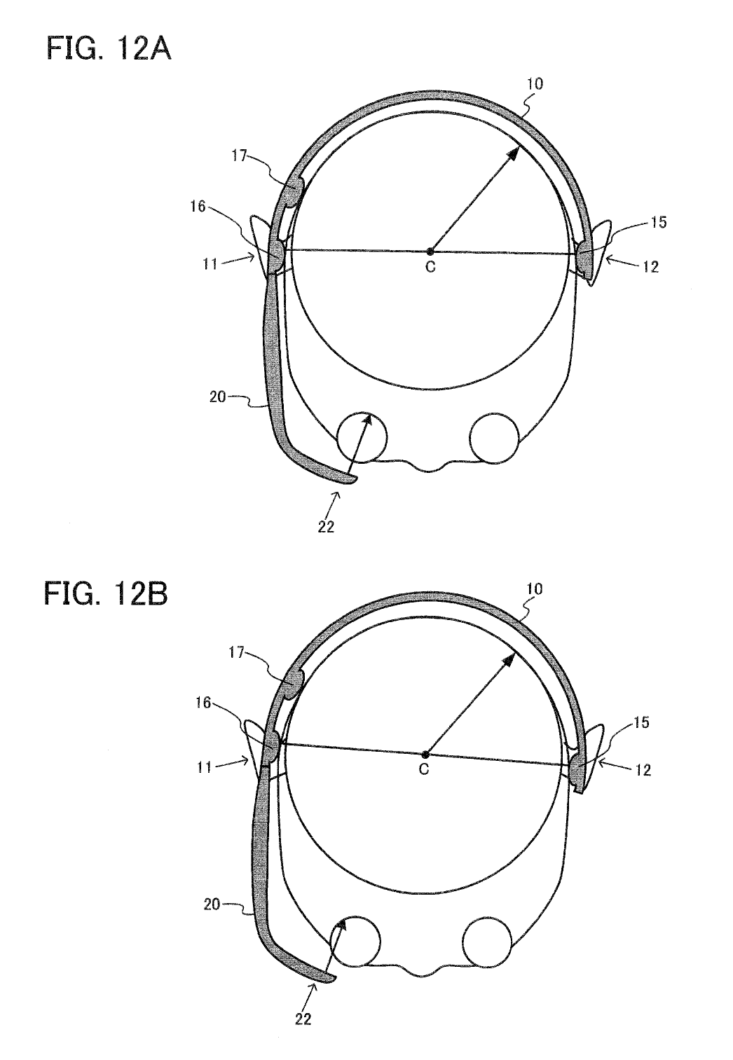

In FIG. 12A, a third protrusion 17 is provided in addition to the first protrusion 15 and the second protrusion 16. Specifically, the first protrusion 15 is provided on the head-facing side surface of the second support target section 12 (around the left ear) of the mounting section 10, and the second protrusion 16 is provided on the head-facing side surface of the first support target section 11 (around the right ear) of the mounting section 10 (or the head-facing side surface of the arm section 20 on the side of the first support target section 11) in the same manner as in FIG. 11A.

The third protrusion 17 is provided on the head-facing side surface of the mounting section 10 on the rear side of the second protrusion 16 (i.e., on the side of the back of the head). Specifically, when the eye piece 22 is disposed in front of the right eye of the user (see FIG. 12A), the protrusion 15 is provided on the left head-facing side surface of the HMD, and the protrusions 16 and 17 are provided on the right head-facing side surface of the HMD. When the eye piece 22 is disposed in front of the left eye of the user, one protrusion is provided on the right head-facing side surface of the HMD, and two protrusions are provided on the left head-facing side surface of the HMD.

When providing the third protrusion 17, it is also possible to prevent a situation in which the mounting section 10 is slidingly displaced toward the back of the head in the same manner as in FIGS. 11A and 11B, and adjust the position of the HMD in the eye width direction (see FIG. 12B). Since the second protrusion 16 and the third protrusion 17 press the head of the user, displacement of the entire HMD in the pitch direction can be more effectively prevented as compared with the configuration shown in FIGS. 11A and 11B. This makes it possible to prevent a situation in which the eye piece 22 is displaced in the vertical direction relative to the visual axis of the user.

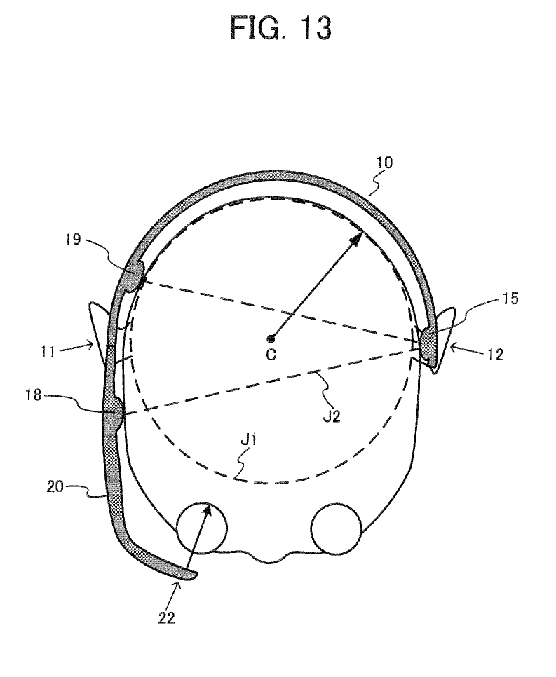

In FIG. 13, the HMD includes a first protrusion 15 provided on the head-facing side surface of the second support target section 12 of the mounting section 10, a second protrusion 18 provided on the head-facing side surface of the mounting section 10 (or the head-facing side surface of the arm section 20), and a third protrusion 19 provided on the head-facing side surface of the mounting section 10. The second protrusion 18 and the third protrusion 19 are disposed on the front side and the rear side of the first support target section 11 (i.e., the ear of the user), respectively. Specifically, the second protrusion 18 is provided on the front side, and the third protrusion 19 is provided on the rear side.

According to the configuration shown in FIG. 13, the center C of a circle indicated by J1 is positioned inside a triangle indicated by J2 having the first protrusion 15, the second protrusion 18, and the third protrusion 19 as vertices. Therefore, since the first protrusion 15, the second protrusion 18, and the third protrusion 19 reliably hold the head of the user, displacement of the entire HMD in the forward direction and the backward direction can be more reliably prevented. Moreover, displacement of the entire HMD in the pitch direction can be more reliably prevented due to the second protrusion 18 and the third protrusion 19. It is also possible to prevent rotation of the HMD in the yaw direction of HMD due to the second protrusion 18 and the like. Note that it may be difficult to adjust the position of the HMD in the eye width direction when using the configuration shown in FIG. 13. However, if the user selects an HMD suitable for the user, the user need not adjust the position of the HMD in the eye width direction each time the user wears the HMD.

4. Mounting of Electronic Parts and the Like

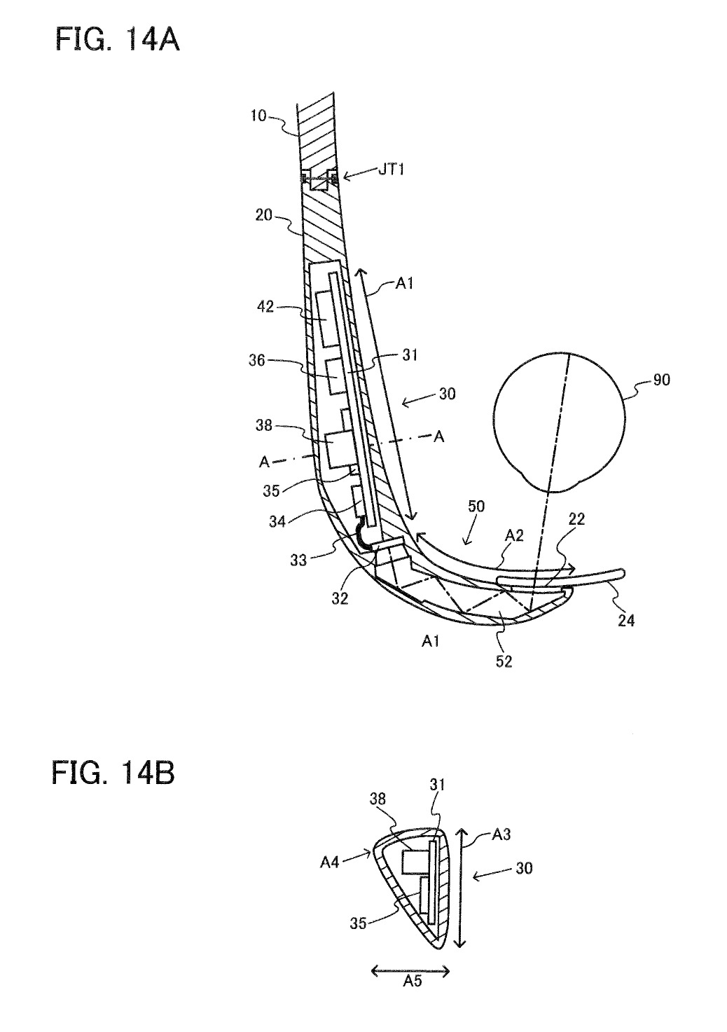

The HMD according to one embodiment of the invention includes electronic parts and optical parts inside the arm section 20. As shown in FIG. 14A, electronic parts including at least a driver 35 that drives a display section 32 (e.g., OLED or LCD) that generates an image displayed on the eye piece 22 are provided in the housing included in the arm section 20, for example. Specifically, the driver 35 that drives the display section 32, a wireless module 38, a secondary battery 42, and the like are provided in the housing included in the arm section 20 as necessary electronic parts. Note that all of these electronic parts need not necessarily be provided. Some of these electronic parts may be omitted.

For example, the arm section 20 includes a first housing 30 disposed on the side of the mounting section 10, and a second housing 50 disposed on the side of the eye piece 22. The first housing 30 and the second housing 50 are formed in the shape of a hollow casing. The electronic parts such as the driver 35 (display driver) that drives the display section 32 (display element) are provided in the first housing 30. An optical part 52 (light-guiding section) that guides the display image light from the display section 32 to the eye piece 22 is provided in the second housing 50.

The first housing 30 is provided in an area of the arm section 20 along one temporal region (right temporal region in FIG. 14A) of the user. Specifically, the first housing 30 is provided in an area along a direction indicated by A1 in FIG. 14A. The temporal region of the user is approximately linear (see H3 in FIG. 11A). In one embodiment of the invention, the first housing 30 is provided along the approximately linear temporal region, and the electronic parts are provided in the first housing 30. This makes it possible to easily mount the electronic parts.

On the other hand, the second housing 50 is provided in an area of the arm section 20 that extends from one end of the first housing 30 (i.e., the position of the display section 32) to the eye piece 22. Specifically, the second housing 50 is provided in an area along a direction indicated by A2 in FIG. 14A.

According to one embodiment of the invention, the electronic parts can be easily mounted by providing the first housing 30 in an area that extends along the direction indicated by A1 and is positioned adjacent to the temporal region that is approximately linear when viewed from above. On the other hand, the second housing 50 is provided in a curved area indicated by A2 that extends from one end of the first housing 30 to the eye piece 22, and the optical part 52 (light-guiding section) that guides the display image light from the display section 32 to the eye piece 22 is provided in the second housing 50. This makes it possible to dispose the electronic parts and the optical parts in an optimum mounting state corresponding to the shape of each section of the arm section 20.

A circuit board 31 on which the electronic parts are mounted is provided in the first housing 30. Specifically, a flexible cable connector 34 that is connected to the display section 32 through a flexible cable 33, the driver 35 that drives the display section 32, a video converter 36, a wireless module 38, the secondary battery 42 (battery), and the like are mounted on the circuit board 31.

As shown in FIG. 14A, the circuit board 31 is disposed in the first housing 30 so that the surface (planar) direction (i.e., the direction along the surface) coincides with the direction along one temporal region (e.g., right temporal region) of the user (i.e., the direction indicated by A1). For example, the circuit board 31 is disposed in the first housing 30 so that the surface (planar) direction extends along the vertical direction when the user wears the HMD. This makes it possible to dispose the tabular circuit board 31 in the first housing 30 by effectively utilizing the area adjacent to the approximately linear temporal region.

Specifically, it is preferable to increase the length of the circuit board 31 in the direction indicated by A1 in FIG. 14A in order to mount a large number of electronic parts on the circuit board 31. According to one embodiment of the invention, the first housing 30 of the arm section 20 is positioned adjacent to the approximately linear temporal region, and the circuit board 31 is provided in the first housing 30. This makes it possible to sufficiently increase the length of the circuit board 31 in the direction indicated by A1, so that a larger number of electronic parts can be mounted on the circuit board 31. Specifically, the internal space of the arm section 20 can be efficiently utilized. This makes it possible to mount a larger number of electronic parts in the arm section 20 having a compact shape.

On the other hand, the light-guiding section that guides the display image light from the display section 32 need not be provided in a linear area, differing from the circuit board 31. Therefore, the second housing 50 is disposed in the curved area indicated by A2 in FIG. 14A, and the optical part 52 (e.g., light-guiding section) is provided in the second housing 50. This makes it possible to efficiently dispose the parts corresponding to the shape of each section of the arm section 20.

FIG. 14B is a cross-sectional view along the line A-A shown in FIG. 14A. As shown in FIG. 14B, the arm section 20 has a triangular vertical cross-sectional shape at the position of the first housing 30. Specifically, the arm section 20 has a triangular vertical cross-sectional shape having a base that extends in a direction indicated by A3 that extends along the surface (planar) direction of the circuit board 31. The driver 35 that drives the display section 32 and the wireless module 38 shown in FIG. 14B are mounted on the circuit board 31.

The wireless module 38 is mounted on the circuit board 31 at a position corresponding to the vertex of the triangular shape indicated by A4. Specifically, the height in a direction indicated by A5 is large at a position corresponding to the vertex indicated by A4. The driver implemented by an integrated circuit device (IC) does not require a large height in the direction indicated by A5. However, since the wireless module 38 includes various parts (e.g., antenna inductor element) necessary for wireless communication in addition to a wireless communication IC, the wireless module 38 requires a sufficient height in the direction indicated by A5.

In FIG. 14B, since the wireless module 38 is mounted at a position corresponding to the vertex of the triangular shape indicated by A4, the wireless module 38 having a large height can be easily mounted on the circuit board 31.

Moreover, the design form of the HMD when viewed in the transverse direction can be improved by forming the arm section 20 to have a triangular cross-sectional shape. Since a plane indicated by A3 in FIG. 14B extends along the temporal region when the user wears the HMD, the contact area of the arm section 20 and the temporal region increases, so that the mounting (wearing) stability of the HMD can be improved. Note that the vertex of the triangular shape need not necessarily form an acute angle. The vertex of the triangular shape may be curved (see FIG. 14B).

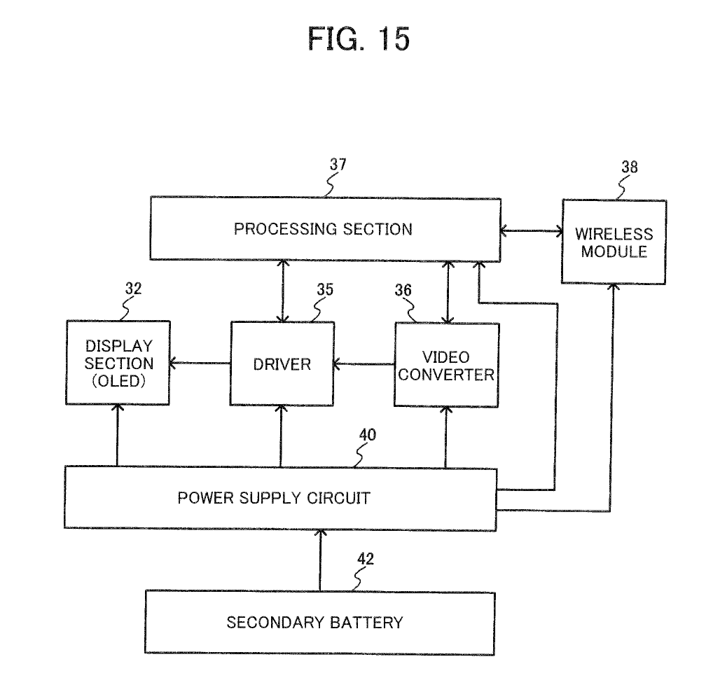

FIG. 15 shows a connection configuration example of the electronic parts included in the HMD. The display section 32 is an organic EL display (OLED), a liquid crystal display (LCD), or the like. The display section 32 includes a plurality of data lines, a plurality of scan lines, and a plurality of pixels (display elements) provided at the intersection points of the data lines and the scan lines.

The driver 35 is a driver (organic EL driver or LCD driver) that drives the display section 32. The driver 35 drives the data lines and the scan lines of the display section 32. Specifically, the driver 35 drives the data lines and the like based on image data from the video converter 36. A display image is thus displayed on the display section 32.

The video converter 36 performs various image processes (e.g., image data conversion process). The video converter 36 is implemented by a display controller or the like. A processing section 37 controls the entire HMD and each circuit block, for example. The processing section 37 is implemented by a processor (e.g., CPU), an ASIC, or the like.

The wireless module 38 receives data (e.g., image data) from a portable electronic instrument (information processing device) possessed by the user via wireless communication, and transmits data to the portable electronic instrument via wireless communication. An image generated by the portable electronic instrument is displayed on the HMD. The wireless module 38 includes a wireless communication IC, an antenna (e.g., inductor element), and the like. A power supply circuit 40 receives power from the secondary battery 42, and supplies a power supply voltage to each circuit block of the HMD.

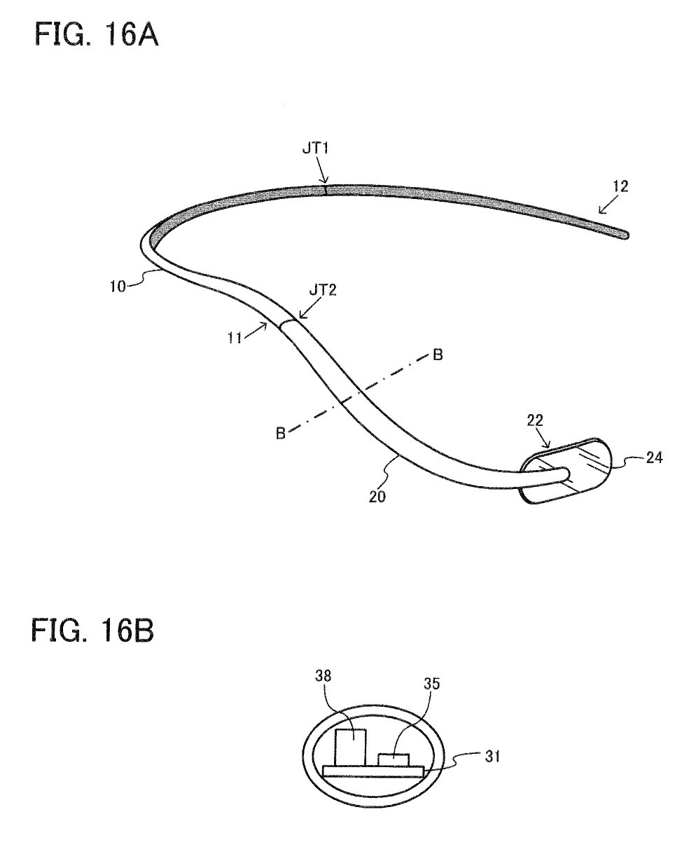

FIGS. 16A and 16B illustrate a modification of the HMD according to one embodiment of the invention. Note that FIG. 16B is a cross-sectional view along the line B-B shown in FIG. 16A. The HMD shown in FIG. 16A is configured so that the arm section 20 has a flat vertical cross-sectional shape (see FIG. 16B). The circuit board 31 is disposed in the housing included in the arm section 20 so that the surface (planar) direction of the circuit board 31 extends along the transverse direction when the user wears the HMD, and the electronic parts such as the driver 35 and the wireless module 38 are mounted on the circuit board 31.

The width of the arm section 20 in the transverse direction when the user wears the HMD increases when employing the cross-sectional shape shown in FIG. 16B. The triangular cross-sectional shape shown in FIG. 14 B has an advantage in that the width of the arm section 20 in the transverse direction can be reduced as compared with FIG. 16B.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings. The configurations, the structure, and the like of the head-mounted display are not limited to those described in connection with the above embodiments. Various modifications and variations may be made.

What is claimed is:

1. A head-mounted display comprising:
a mounting section that includes a first support target section, and is worn along a back of a head of a user so that the mounting section holds each side of the head of the user, the first support target section being supported by a base of one of a right ear and a left ear of the user; and
an arm section that is formed to extend forward from one end of the mounting section positioned on a side of the first support target section along one temporal region of the user, and includes an eye piece that faces one of a right eye and a left eye of the user, the eye piece being provided at a front-side end of the arm section,
a position of a center of gravity of the head-mounted display in a horizontal direction being set to a position on a front side of the first support target section or a position around the first support target section when viewed from a side of the one temporal region.

2. The head-mounted display as defined in claim 1,
an angle θ formed by a first direction and a second direction being equal to or greater than 145°, the first direction being a direction from the first support target section to a rear end of the mounting section, and the second direction being a direction from the first support target section to the eye piece provided on the arm section when viewed from the side of the one temporal region.

3. The head-mounted display as defined in claim 2,
the angle θ being equal to or greater than 145° and less than 220°.

4. The head-mounted display as defined in claim 3,
the angle θ being equal to or greater than 145° and less than 180°.

5. The head-mounted display as defined in claim 1,
a position of the center of gravity in a vertical direction being set to a position below the first support target section or a position around the first support target section when viewed from the side of the one temporal region.

6. The head-mounted display as defined in claim 1,
the mounting section including a second support target section that is supported by the base of the other of the right ear and the left ear.

7. The head-mounted display as defined in claim 6, further comprising:
a protrusion that is provided on at least one of a head-facing side surface of the second support target section of the mounting section, a head-facing side surface of the first support target section of the mounting section, and a head-facing side surface of the arm section on a side of the first support target section.

8. The head-mounted display as defined in claim 6, further comprising:
a first protrusion that is provided on a head-facing side surface of the second support target section of the mounting section;
a second protrusion that is provided on a head-facing side surface of the first support target section of the mounting section or a head-facing side surface of the arm section on a side of the first support target section; and
a third protrusion that is provided on a head-facing side surface of the mounting section on a rear side of the second protrusion.

9. The head-mounted display as defined in claim 6, further comprising:
a first protrusion that is provided on a head-facing side surface of the second support target section of the mounting section;
a second protrusion that is provided on a head-facing side surface of the mounting section or a head-facing side surface of the arm section; and
a third protrusion that is provided on the head-facing side surface of the mounting section,
the second protrusion and the third protrusion being disposed on a front side and a rear side of the first support target section, respectively.

10. The head-mounted display as defined in claim 1,
the mounting section being formed by an elastic member that holds each side of the head of the user.

11. The head-mounted display as defined in claim 1, further comprising:
a circuit board that is provided in a housing included in the arm section, an electronic part being mounted on the circuit board,
the circuit board being disposed in the housing so that a surface direction of the circuit board extends along the one temporal region.

12. The head-mounted display as defined in claim 1,
the arm section having a triangular vertical cross-sectional shape having a base that extends in a direction along the one temporal region.

13. The head-mounted display as defined in claim 1, further comprising:
a first joint for folding the head-mounted display, the first joint being provided in an intermediate area between one end and the other end of the mounting section; and
a second joint for folding the head-mounted display, the second joint being provided in a connection area of the mounting section and the arm section.

14. The head-mounted display as defined in claim 13,
the head-mounted display being bent at the second joint so that a direction from the second joint to the eye piece becomes parallel to a direction from the second joint to the first joint in a state in which the head-mounted display is bent at the first joint.

15. The head-mounted display as defined in claim 13,
the head-mounted display being bent at the second joint along a plane including the mounting section when the head-mounted display is bent at the first joint.

16. The head-mounted display as defined in claim 1, further comprising:
a protection section that is provided at one end of the arm section, and protects the one of the right eye and the left eye,
the protection section being formed by an elastic transparent member, and provided so that the protection section is positioned between the one of the right eye and the left eye and the eye piece when the user wears the head-mounted display.

17. A head-mounted display comprising:
a mounting section that includes a first support target section, and is worn along a back of a head of a user so that the mounting section holds each side of the head of the user, the first support target section being supported by a base of one of a right ear and a left ear of the user; and
an arm section that is formed to extend forward from one end of the mounting section positioned on a side of the first support target section along one temporal region of the user, and includes an eye piece that faces one of a right eye and a left eye of the user, the eye piece being provided at a front-side end of the arm section,
an electronic part at least including a driver that drives a display section that generates a display image displayed on the eye piece being provided in a housing included in the arm section.

18. The head-mounted display as defined in claim 17,
the arm section including a first housing disposed on a side of the mounting section, and a second housing disposed on a side of the eye piece,
the electronic part being provided in the first housing, and
an optical part that guides display image light from the display section to the eye piece being provided in the second housing.

19. The head-mounted display as defined in claim 18,
the first housing being provided in an area of the arm section that extends along the one temporal region, and
the second housing being provided in an area of the arm section that extends from one end of the first housing to the eye piece.

20. The head-mounted display as defined in claim 19, further comprising:
a circuit board that is provided in the first housing, the electronic part being mounted on the circuit board,
the circuit board being disposed in the first housing so that a surface direction of the circuit board extends along the one temporal region.

21. The head-mounted display as defined in claim 20,
the arm section having a triangular vertical cross-sectional shape at a position of the first housing, the triangular vertical cross-sectional shape having a base that extends in a direction along the surface direction of the circuit board.

22. The head-mounted display as defined in claim 21,
a wireless module being mounted on the circuit board as the electronic part,
the wireless module being mounted on the circuit board at a position corresponding to a vertex of the triangular shape.

23. The head-mounted display as defined in claim 17, further comprising:
a circuit board that is provided in the housing included in the arm section,
the electronic part being disposed in the housing included in the arm section so that a surface direction of the circuit board extends along the one temporal region.

24. The head-mounted display as defined in claim 17,
the arm section having a triangular vertical cross-sectional shape at a position of the housing, the triangular vertical cross-sectional shape having a base that extends in a direction along the one temporal region.

25. The head-mounted display as defined in claim 17,
the driver that drives the display section, a wireless module, and a secondary battery being provided in the housing included in the arm section as the electronic part.

26. The head-mounted display as defined in claim 17,
an angle θ formed by a first direction and a second direction being equal to or greater than 145°, the first direction being a direction from the first support target section to a rear end of the mounting section, and the second direction being a direction from the first support target section to the eye piece provided on the arm section when viewed from the side of the one temporal region.
